(19) United States
(12) Patent Application Publication
(10) Pub. No.: US 2007/0239424 A1
(43) Pub. Date: Oct. 11, 2007

(54) Foreign Language Communication Aid

(76) Inventor: Roger Payn, Cambridgeshire (GB)

Correspondence Address: BROOKS KUSHMAN P.C., 1000 TOWN CENTER, TWENTY-SECOND FLOOR, SOUTHFIELD, MI, 48075, US

(21) Appl. No.: 10/597,886

(22) PCT Filed: Feb. 12, 2005
(86) PCT No.: PCT/GB05/50015

§ 371 Date: Aug. 10, 2006

(30) Foreign Application Priority Data
Feb. 13, 2004 (GB) 0403202.5

(51) Int. Cl. G06F 17/27

(52) U.S. Cl. 704/3

(57) ABSTRACT

The invention addresses the problem of communicating effectively in a foreign language. A phrase to be communicated is selected from an address in a table (4A) and is displayed, in the user's mother tongue, on one side (3A) of a display so that it can be seen by the user. Displayed alongside it is the content of a similar address from table (C), this being a phonetic version of a translation of the phrase into a foreign language. The foreign language phrase is extracted from a similar address in table (4B) and is displayed on an opposite side (3B) of the screen. In use, the user can attempt to speak in the foreign language by using the phonetic version of the phrase; whilst the person to whom the user is speaking can understand what is being said by referring, if necessary, to the side (3B) of the screen. In an alternative version, information equivalent to that in database (4) is printed on cards in such a way that it can be presented on two sides in a way equivalent to the FIG. 1 arrangement.

This invention relates to a communication aid for assisting the user to communicate in a foreign language. In this specification the conventional terminology L1 will be used to indicate a user's native language and L2 to indicate a first foreign language.

Many proposals have been made in the past for devices designed to help the user to learn or use a foreign language.

For example, patent specification GB 2267835 describes a deck of playing cards intended for this purpose. One side of each card carries a word or phrase in the user's native language, in a foreign language and in a phonetic representation of the foreign language so that the players, whilst playing the game, become accustomed to the foreign language in written and spoken form.

Other known language teaching aids are described in patent specifications GB2319066 and GB 1127038. These also use playing cards marked on one face with a phrase in the user's native language and in a foreign language. However in these examples each card also carries a pictorial representation of the relevant phrase.

Whilst these known games are probably of some assistance when learning a foreign language, none of them provides a direct aid to immediate communication with a person who speaks only in a foreign language. For that purpose it is necessary to use a phrase book or electronic translator to find the foreign language equivalent of the appropriate phrase along with the phonetic equivalent. Unfortunately, phrase books and electronic translators are not entirely effective because the user's pronunciation of the words may not be sufficiently good for him to be understood

It is believed that this invention will make it possible for someone having no knowledge of a foreign language (a) to communicate relatively spontaneously in a foreign language, (b) to be understood and (c) if his pronunciation is not perfect, to be corrected.

According to a first aspect of this invention there is provided a communication aid for communicating from a first language L1 to a second language L2, comprising a database of possible messages to be communicated, each message being recorded in a first language L1, a second language L2 and a phonetic equivalent of the second language, the communication aid including a two-sided visual display facility designed to allow a selected message to be withdrawn from the database and to be displayed in the first language L1 and phonetically in the second language L2 on a first side of the display facility, and in a second language L2 on a second side of the display facility.

Another aspect of the invention provides a communication aid comprising: a display device for displaying information to two people on different sides of the display device; means for entering or selecting information in a first language and displaying it on one of the two sides; and means for displaying a translation of the information into a second language on the other side.

Yet another aspect of the invention provides a communication aid comprising: a display device for displaying information to two people (a) and (b) on different sides of the display device; a database of information partitioned into two parts (a) and (b) containing information appropriate to the respective aforesaid people; means linking each element of information in part (a) with an element of information in part (b); and means for displaying a selected element of information on one side of the display device and the associated element of information on the other side of the display device.

It will be appreciated that, in use, the display facility is positioned so that the first side is facing the user, who speaks only the first language L1; whilst the second side faces the person who understands only the second, foreign, language L2. Using the phonetic display, the user reads aloud the message in the foreign language L2. Because the second person can see the message, written in his own language on the second side of the display, he has no difficulty understanding what is said despite any imperfections of pronunciation.

Furthermore, if the pronunciation is not correct he is likely instinctively to repeat the phrase with the correct pronunciation: this scenario giving the user an ideal opportunity to perfect his pronunciation skills and eventually to be able to converse fluently in the foreign language.

The first side of the display device may carry a marking in language L1 to explain that the user should read from that side. Alternatively (or additionally) the second side can be marked, in language L1, to indicate that the user should show that side to the second person. The second side is preferably also marked with a greeting in the foreign language, for example the words “can you please help me” in language L2.

The invention could be implemented electronically, with the database being an electronic library of phrases, which can be addressed and read out using a keyboard or other user interface via a suitably programmed processor. Such an electronic implementation of the invention could be embodied as a fixed installation with a desktop screen or as a hand-held portable device.

In another embodiment of the invention, the database and display facility are embodied as a pack of cards each carrying printed wording. By assembling a number of such cards in a pack, each carrying a different message, it is a simple matter to select a card, carrying a desired message, whilst concealing the others. The cards may be formed with tabs or be colour coded or otherwise formed so as to facilitate the selection of a card suitable for the circumstances in which the user is likely to find himself. However this is not considered to be an essential element of the invention.

Where cards are used, it is an advantage for each card to display two possible messages on respective ends, the writing on the different ends being inverted relative to each other. This allows one end of the card, carrying the message not being used, to be used for holding the card either within the pack or in the user's hand, this end being thus concealed from view whilst the opposite end is displayed.

Two possible ways of implementing the invention will now be described with reference to the accompanying drawings, in which:—

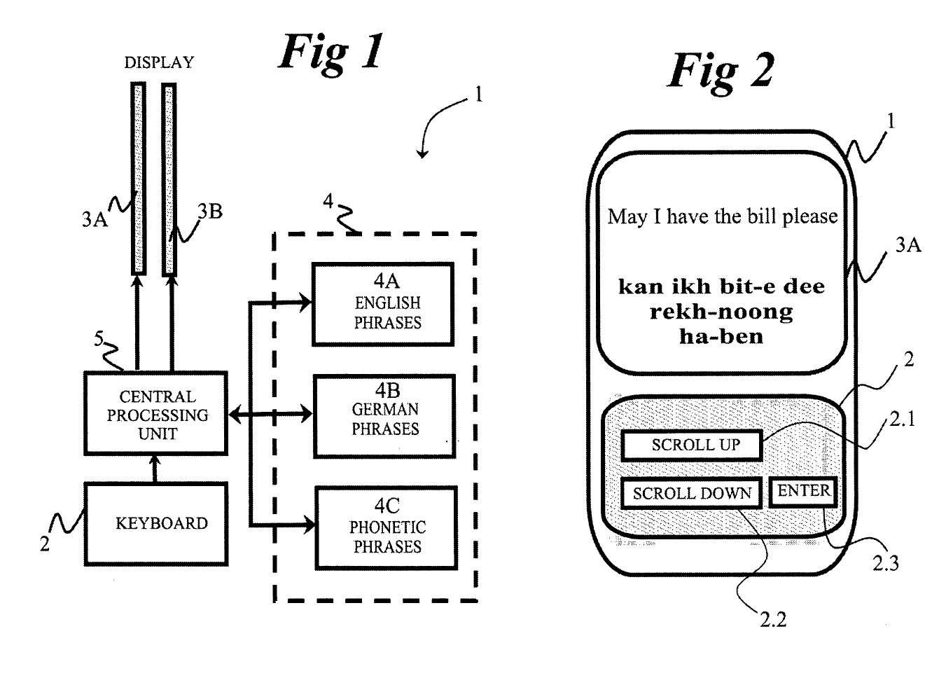

FIG. 1 is a schematic block diagram illustrating an electronic communication aid constructed in accordance with the invention;

FIG. 2 is a front elevation of the communication aid of FIG. 1;

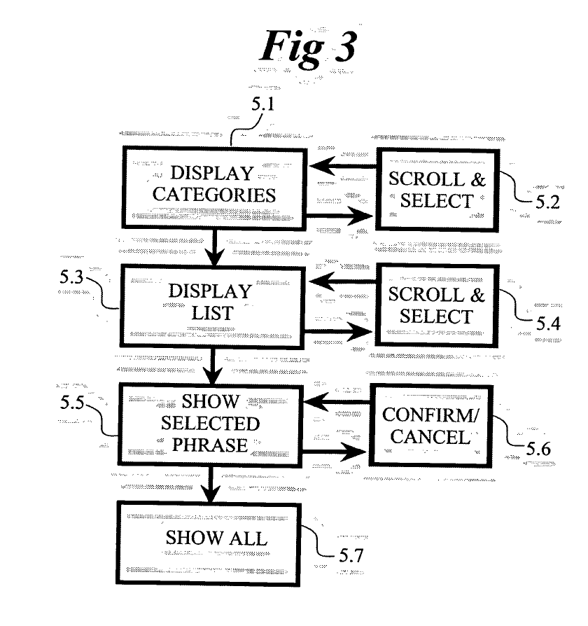

FIG. 3 is a flow diagram illustrating a control program for the processor illustrated in FIG. 1;

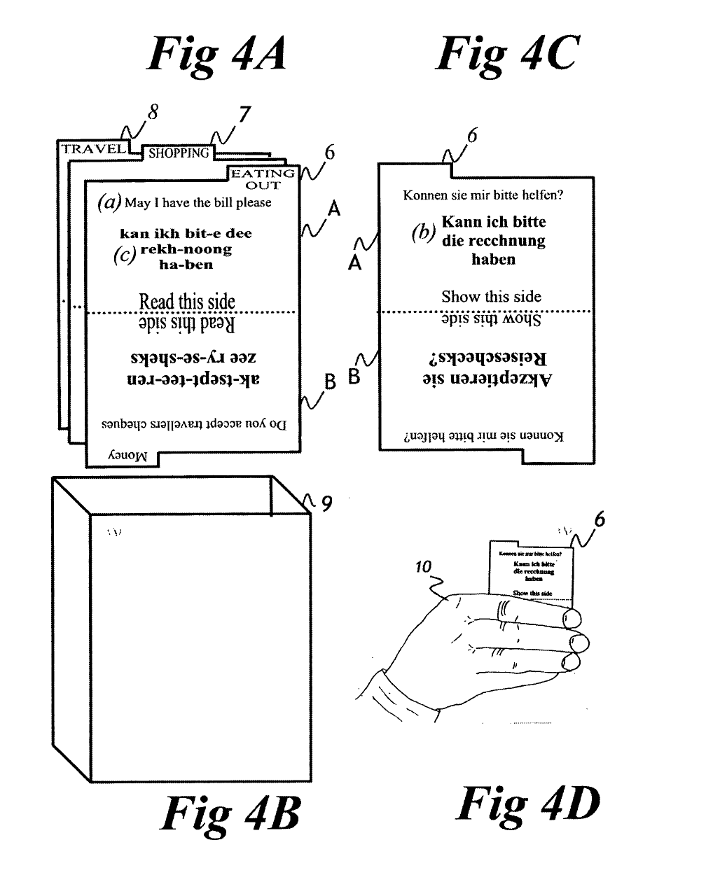

FIG. 4A shows, schematically, a pack of cards forming a communication aid forming a second embodiment of the invention;

FIG. 4B shows a sleeve for receiving the pack of cards shown in FIG. 4;

FIG. 4C shows the reverse of the card whose front face is visible in FIG. 4; and

FIG. 4D shows how the card of FIG. 3 may be held in the hand of the user.

Referring first to FIGS. 1 and 2, there is shown a hand-held electronic unit 1 having a control panel 2, two LCD displays 3A and 3B positioned back to back, a database 4 having three parts 4A, 4B and 4C and a central processing unit 5. The control panel 2 is used, via processor 3, to browse through a large number of useful phrases, stored at 4A and sorted into categories eg “travel,” “shopping,” “eating out,” “money” etc. These phrases are expressed in the user's home language L1, which is assumed, for the purpose of this description, to be English. When the desired phrase has been found the control panel is used to select it.

The database parts 4A, 4B and 4C in this embodiment of the invention are identically flash memory chips organised as look-up tables. (In alternative arrangements any other non-volatile memory or ROM may be used.) Each address in flash memory chip 4A contains an L1 language phrase (assumed to be English in this example) whilst the identical address in chip 4B contains a foreign language L2 equivalent (assumed to be German for the purpose of this example). In the same address within memory chip 4C is stored the phonetic equivalent of the L2 language version. Of course, in an alternative arrangement, a single physical memory unit could be used in place of the three chips, this single unit being divided into three parts by virtual partitions defined by the programming of the processor 5

Suppose that the user selects the phrase “May I have the bill please” from address X₁, Y₁ in the database 4A. In response to this selection the processor 5 downloads from address X₁, Y₁ of the database part 4C the phonetic wording of a German translation “Kan ikh bit-e dee rekh-noong ha-ben.” This is displayed on display 3A alongside the English phrase selected from database 4A as shown on FIG. 2. It also downloads from address X₁, Y₁ of database part 4B the foreign language translation “Kann ich bitte die recchnung haben.” The latter is displayed on the opposite side 3B of the display.

FIG. 3 shows the functions performed by the processor 5 in more detail. It is programmed so that it switches on in response to operation of any key and displays, as shown by block 5.1, a list of phrase categories stored at 4A. Keys 2.1 and 2.2 permit the user to scroll through these categories, as indicated by block 5.2, and can make a selection by using the “enter” button 2.3 to select a highlighted item. This selection process causes a list of abbreviated phrases in the selected category to be displayed as shown at 5.3. Again, the user can scroll through this list, as indicated at 5.4, and can select a particular phrase using the “enter” button to select a highlighted item. The selected phrase is then displayed in its entirety as shown at 5.5. The user can then confirm or cancel this selection as indicated at 5.6.

If confirmed, the information from database part 4C (FIG. 1) located at an address identical to the address of the selected phrase in part 4A, is displayed alongside it on the screen 3A exactly as shown on FIG. 2, this being indicated by functional block 5.7. Simultaneously, the information from database part 4B, located at an address identical to the address of the selected phrase in part 4A, is displayed on the screen 3B.

In use, the user selects an appropriate phrase and can then view a phonetic version of its translation into a foreign language, allowing him to say the words in the foreign language. At the same time the foreign language words are displayed on the opposite side of the device so that they can easily be shown to the person to whom the user is speaking. This allows the foreign person to understand what is being said even if the pronunciation is not good.

This electronic implementation of the invention has been described only by way of example and many variations are possible. For example, the database can be extended to include another database part containing phonetic equivalents of language L1 so that the device can be used by native L1 or L2 speakers. Also, the same information could be included in more than two languages, with a suitable selection facility being included to allow the user to set the device to the combination of languages that is required for any particular situation.

A feature of the illustrated device is that it is particularly simple because it requires no complex linguistic translation device but relies only on predetermined phrases loaded into its memory. However, it would be possible in other embodiments to include a conventional translation mechanism and multi-language dictionary instead of or in addition to the partitioned database described.

In another variation, the invention could be employed in a fixed installation designed for use in office type environments where an official eg a bank cashier, customs or immigration officer, hotel receptionist, or professional or personal advisor such as a doctor or pharmacist needs to communicate with a person in a foreign language. It is believed to be particularly valuable in situations which call for a limited number of standard questions to be asked. In this type of situation it may be advantageous to include a second input device to allow the foreign person to input answers to the questions. A touch screen could be used for this purpose. A touch screen could also be used by the principal user to selected data to be communicated, ie to perform the function of the “enter” key shown at 2.3 on FIG. 2. In yet another variation, the user could be provided with an audible spoken representation of the foreign language phrase eg via an earpiece, instead of or in addition to the written phonetic version. The person speaking language L2 as a native language could also be provided with a pictorial indication of the relevant phrase in addition to or instead of the L2 language words. The language L2 could consist of or include pictorial representations for the benefit of people who are illiterate.

Another embodiment of the invention is shown in FIGS. 4A to 4D. Referring first to FIG. 4A there is shown a pack of cards, of which in practice there would be many, but only three of which are shown, at 6, 7 and 8 for simplicity of illustration. These cards carry printed information which forms a database of phrases in three different subject matter sections as in the databases of the earlier described embodiment, in the two languages L1 and L2. The sections are defined by the positions of tabs as shown at each end of each card.

Each card is divided into two as shown at 6A and 6B and each end of each card carries at (a) a phrase in the native language L1 of the user, which is assumed for the purposes of this example to be English. So, for example, the top end of the card 6 shown at the front of the pack on FIG. 4A has a tab indicating that it belongs in the “eating-out” section and carries at (a) the message in the English language “May I have the bill please?” It also carries at (c) the phonetic equivalent of a translation into a foreign language L2”, in this case German, and an indication that this is the side of the card, which the user should read.

By inverting the card 6 it becomes possible to read the inverted writing, which is similar to that previously described but which relates to a different message: “do you accept travellers cheques?” in the “money section

The reverse side of the card 1 is shown on FIG. 4C and carries on its two ends, A and B, a greeting in the foreign language together with, at position (b) a translation of the English language message on the opposite face of the card. Thus the information at positions (a), (b) and (c) of the cards is the same as the information in the parts 4A, 4B and 4C of the database 4 of FIG. 1.

The cards are kept in a cardboard sleeve 9 shown in FIG. 4B, which allows a selected card to be pushed through either end so as to expose the chosen message. Alternatively, the selected card can be completely removed from the sleeve and held in the hand as shown in FIG. 4D so that the selected message is exposed whilst the inverted message on the other end of the card is concealed by the user's hand 10.

Both embodiments of the invention share the feature that there are three database parts (a), (b) and (c) containing respectively language L1 phrases; corresponding language L2 phrases; and corresponding language L3 phonetic equivalent phrases. In FIG. 1 these are three electronic database sectors 4A, 4B and 4C. In the FIG. 4 to 7 embodiment they are the groups of (a) English phrases, (b) German phrases and (c) German phonetic phrases printed at assigned positions on the cards. In both embodiments there is a mechanism for associating the corresponding data elements in the three database parts a, b and c; namely the fact that they are printed on the same half of the same card in one embodiment; and the fact that they are located at database addresses which can be identified by the processor as being related, in the other embodiment. An important feature of both of the illustrated embodiments of the invention is that there is some means for linking this related information either electronically or physically.

It will be appreciated that many further variations of design and implementation are possible within the scope of the invention as defined by the appended claims. However, whatever implementation is employed, it is believed that the invention, because of its two-sided display feature, will allow the user to communicate in a foreign language much more easily and fluently than has hitherto been possible using conventional phrase books and translating devices.

1. A communication aid for communicating from a first language L1 to a second language L2, comprising a database of possible messages to be communicated, each message being recorded in a first language L1, a second language L2 and a phonetic equivalent of the second language, characterized in that the communication aid includes a two-sided visual display facility designed to allow a selected message to be withdrawn from the database and to be displayed in the first language L1 and phonetically in the second language L2 on a first side of the display facility, and in a second language L2 on a second side of the display facility.

2. A communication aid according to claim 1 characterized by an electronic memory having three different parts for storing phrases or words respectively in the first language L1, phonetically in the second language L2 and in the second language L2, and means defining an association between an address in each of the three parts.

3. A communication aid according to claim 1 characterized by a pack of cards, each carrying a respective message, the message being printed in language L1 and in the phonetic equivalent of L2 on one side of the card, and in language L2 on the other side of the card.

4. A communication aid according to claim 1 characterized in that the second side of each card also carries a greeting in language L2.

5. A communication aid according to claim 1, characterized in that the visual display facility is designed to be hand-held and is adapted to carry two messages simultaneously, with one message being inverted relative to the other and the messages being displayed at opposite ends of the display.

6. A communication aid characterized by: a display device for displaying information to two people (a) and (b) on different sides of the display device; database of information partitioned into three parts (a), (c) and (b) parts (a) and (b) containing information appropriate to the respective aforesaid people; means linking each element of information in part (a) with an element in part (b) and an element in part (c); and means for displaying a selected element of information from part (a) with the associated element from part (c) on one side of the display device and the associated element of information (b) on the other side of the display.

7. A communication aid according to claim 6 characterized in that part (a) contains phrases in a first language and part (b) contains corresponding phrases in a second language.

8. A communication aid comprising: a display device for displaying information in two people on different sides of the display device; characterized by means for entering or selecting information in a first language and displaying it on one of the two sides; and means for displaying a translation of the information in a second language on the other side.

9. (canceled)

10. A communication aid according to claim 3 characterized in that the second side of each card also carries a greeting in language L2.

11. A communication aid according to claim 3, characterized in that the visual display facility is designed to be hand-held and is adapted to carry two messages simultaneously, with one message being inverted relative to the other and the messages being displayed at opposite ends of the display.

12. A communication aid according to claim 4, characterized in that the visual display facility is designed to be hand-held and is adapted to carry two messages simultaneously, with one message being inverted relative to the other and the messages being displayed at opposite ends of the display.
